(19) United States
(12) Patent Application Publication
(10) Pub. No.: US 2026/0078472 A1
(43) Pub. Date: Mar. 19, 2026

(54) DYSPROSIUM-RICH NICKEL-TUNGSTEN ALLOY MATERIAL FOR NUCLEAR SHIELDING AND PREPARATION METHOD THEREFOR

(71) Applicant: Shanghai Nuclear Engineering Research & Design Institute Co., Ltd., Shanghai (CN)

(72) Inventors: Yong WANG, Shanghai (CN); Qiliang MEI, Shanghai (CN); Xueshan XIAO, Shanghai (CN); Qianxue DING, Shanghai (CN); Cong LI, Shanghai (CN); Jie PAN, Shanghai (CN); Xiaolin HUANG, Shanghai (CN); You SHI, Shanghai (CN); Yaru FU, Shanghai (CN); Jing GAO, Shanghai (CN); Chao PENG, Shanghai (CN); Lanfang MAO, Shanghai (CN); Shengqin GAO, Shanghai (CN); Ziqiang ZHU, Shanghai (CN); Hui LI, Shanghai (CN)

(73) Assignee: Shanghai Nuclear Engineering Research & Design Institute Co., Ltd., Shanghai (CN)

(21) Appl. No.: 19/108,331

(22) PCT Filed: Jul. 20, 2023
(86) PCT No.: PCT/CN2023/108275

§ 371 Date: Mar. 3, 2025

(30) Foreign Application Priority Data
Sep. 2, 2022 (CN) 202211071009.2

(51) Int. Cl. C22C 19/05; B22D 21/02; C22C 1/02; C22F 1/10; G21F 1/08

(52) U.S. Cl. CPC C22C 19/053; B22D 21/025; C22C 1/023; C22F 1/10; G21F 1/085

(57) ABSTRACT

The present application relates to a dysprosium-rich nickel-tungsten alloy material for nuclear shielding, the composition thereof comprising components of the following mass percentage: C: 0.002-0.02%, W: 5.0-35.0%, Cr: 15.0-30.0%, Dy: 1.0-4.0%, and the remaining components are nickel and unavoidable impurities. A preparation method for the dysprosium-rich nickel-tungsten alloy material for nuclear shielding is also provided. In the present application, a high-dysprosium and high-tungsten nickel-tungsten alloy material is prepared by adding an appropriate ratio of nickel, chromium, tungsten, and dysprosium, and has the advantages of high strength, good plasticity and toughness, corrosion resistance and excellent processing and formability, and can be used as an integrated material of a neutron and photon synergistic shielding functional structure.

### TECHNICAL FIELD

The present invention relates to the technical field of special alloy materials for nuclear energy, and specifically to a dysprosium-rich nickel-tungsten alloy material for nuclear shielding and a preparation method therefor.

### BACKGROUND

With the development of society, human beings' demands for energy are gradually increasing, and traditional fossil energy is facing depletion. Nuclear energy, as a kind of energy with high energy density, cleanness and low carbon, is an important means to ensure national energy security and promote energy conservation and emission reduction. Vigorously developing nuclear energy has become a strategic focus of China's medium and long-term energy development plan. When the concentration of fissionable isotopes in a nuclear reactor core drops to the point where a given power output cannot be maintained, the fuel in the core becomes spent fuel and needs to be discharged. As most spent fuel is discharged from nuclear power plants at the end of its working life, the capacity of reactor storage pools is getting saturated. The question what to do with spent fuel has therefore become a global issue. The spent fuel discharged from nuclear reactors is extremely radioactive, accompanied by the release of certain neutrons and photons, as well as the release of heat. After the spent fuel assemblies are discharged from the reactor, they are generally stored in the spent fuel pool for a certain period of time and then transported to an off-reactor storage facility for storage, or directly transported to a reprocessing plant for processing and disposal. Usually, 25 tons of spent fuels may be discharged annually for each million-kilowatt nuclear power unit. At present, China's accumulated spent fuel has reached 1,000 tons or more; and according to the current scale and speed of nuclear power development in China, the accumulated spent fuel would reach 20,000 to 25,000 tons by 2030, requiring a large amount of nuclear shielding materials during storage and transportation.

On the other hand, with the development of movable small nuclear reactors, the demand for “weight/volume reduction” has put forward higher lightweight and efficient requirements for shielding materials, and “collaborative shielding” for neutrons and photons and “structural/functional integration” of shielding materials are important development directions for the demand for “weight/volume reduction”. The currently widely used neutron shielding material is boron steel. In recent years, austenitic stainless steels with 0.6% by mass of B and 1.0% by mass of B have been produced by continuous casting with high strength, excellent corrosion resistance, and good neutron absorption ability. However, the solubility of boron in stainless steel is low, and the addition of excessive boron will cause precipitation of boride (Fe, Cr)₂B, resulting in greatly reduced hot ductility, making it difficult to hot process boron steel with a higher boron content. Moreover, B₄C/Al neutron absorbing materials have problems such as complex process, severe interface reaction between B₄C and Al, corrosion resistance, and ageing, and polymer neutron absorbing materials such as boron-containing polyethylene and lead-boron polyethylene have problems such as corrosion resistance, high temperature resistance and ageing. Secondly, B₄C/Al materials and polymer neutron absorbing materials can be used as structural materials only when stainless steel plate support is present on the outer layer, which greatly limits the application and development of these neutron absorbing materials. In addition, current shielding materials for neutrons and photons are generally manufactured separately and then combined. For example, lead plates or other high-density materials with high atomic number are added after the neutron shielding material to shield photons, so as to achieve the effect of collaborative shielding for neutrons and photons, however, this is very detrimental to the need for optimizing space layout and “weight/volume reduction”.

Furthermore, in response to the requirement of “weight/volume reduction”, in addition to excellent neutron and photon collaborative shielding functions, shielding materials also need excellent mechanical properties, high temperature resistance, etc. to meet the requirements of structural materials. Therefore, it is urgent to develop a new neutron and photon collaborative shielding structure and function integrated material with simple production process and easy processing.

### SUMMARY

In order to solve the above problems, the present application provides a dysprosium-rich nickel-tungsten alloy material for nuclear shielding and a preparation method thereof. The prepared alloy material has good compatibility, high strength, good plasticity and toughness, corrosion resistance, and radiation resistance. The production process is simple and it is easy to process. The alloy material can be used as a structure/function integrated material for storage and transportation of reactor spent fuel and radiation shielding for small mobile nuclear reactors, and has excellent thermal processing properties.

A first aspect of the present application provides a dysprosium-rich nickel-tungsten alloy material for nuclear shielding, wherein a composition of the material includes the following components in percentage by mass: C: 0.002-0.02%, W: 5.0-35.0%, Cr: 15.0-30.0%, Dy: 1.0-4.0%, and a balance of nickel and unavoidable impurities.

In one embodiment, the composition of the dysprosium-rich nickel-tungsten alloy material for nuclear shielding includes the following components in percentage by mass: C: 0.002-0.02%, W: 5.0-25.0%, Cr: 15.0-30.0%, Dy: 1.0-4.0%, and the balance of nickel and unavoidable impurities.

In one embodiment, the composition of the dysprosium-rich nickel-tungsten alloy material for nuclear shielding includes the following components in percentage by mass: C: 0.002-0.02%, W: 5.0-25.0%, Cr: 15.0-25.0%, Dy: 1.0-3.0%, and the balance of nickel and unavoidable impurities.

In one embodiment, the composition of the dysprosium-rich nickel-tungsten alloy material for nuclear shielding includes the following components in percentage by mass: C: 0.002-0.02%, W: 15.0-25.0%, Cr: 15.0-20.0%, Dy: 1.0-3.5%, and the balance of nickel and unavoidable impurities.

A structure of any of the above dysprosium-rich nickel-tungsten alloy materials for nuclear shielding is composed of austenite and a second phase (Ni, Cr, W)₅Dy intermetallic compound.

The second phase (Ni, Cr, W)₅Dy in the above dysprosium-rich nickel-tungsten alloy for nuclear shielding is distributed along a grain boundary of the austenite in a matrix.

After being subjected to hot forging, hot rolling and annealing heat treatment processes, any of the above dysprosium-rich nickel-tungsten alloy materials for nuclear shielding has a tensile strength at break at room temperature in a range of 650-850 MPa, and an elongation at break in a range of 20.0-40.0%.

The present application further provides a method for preparing any of the above dysprosium-rich nickel-tungsten alloy materials for nuclear shielding, including the following steps:
(1) mixing all raw materials weighed after batching the raw materials according to the composition in percentage by mass, and performing vacuum induction melting by adopting a vacuum induction melting process to obtain an alloy melt; and
(2) casting the alloy melt prepared in step (1) into shape to obtain an alloy ingot, and performing hot forging, hot rolling and annealing heat treatment processes on the alloy ingot sequentially to finally obtain the dysprosium-rich nickel-tungsten alloy material for nuclear shielding.

In the above method for preparing the dysprosium-rich nickel-tungsten alloy material for nuclear shielding, wherein the vacuum induction melting process includes the following steps:
a. putting the raw materials weighed after batching into a vacuum induction heating furnace, evacuating the furnace to 3×10⁻⁴ Pa, and then introducing high-purity argon gas therein as a protective gas; and
b. heating the vacuum induction heating furnace up to 1700° C. at a heating rate of 100°C/min, and maintaining the temperature for 10 minutes to obtain the alloy melt.

The beneficial effects of the present application are as follows:
1. Compared with traditional boron steel or B₄C/Al-based composite materials, the method according to the present application adopts a vacuum induction melting process, and (Ni, Cr, W)₅Dy is formed by comprehensive batching and the melting process; moreover, the Dy element has a “chain” neutron absorption behavior, and Dy-161 can capture neutrons for 5 times before completely losing its absorption capacity and is a “slow-burning” absorber with excellent durability; after casting molding, processes such as hot forging, hot rolling, cold rolling and annealing treatment are performed, and a rod or plate of dysprosium-rich nickel-tungsten alloy material for nuclear shielding is finally produced.
2. The dysprosium-rich nickel-tungsten alloy material for nuclear shielding of the present application has the characteristics of high strength, corrosion resistance and excellent processing formability. After hot rolling and annealing treatment of the steel within the composition range, the tensile strength at break at room temperature is in the range of 650 MPa to 850 MPa, the elongation at break is in the range of 20.0% to 40.0%, and excellent corrosion resistance and hot workability are provided.
3. Experiments show that compared with traditional boron steel or B₄C/Al-based composite materials, under the same material thickness, the dysprosium-rich nickel-tungsten alloy material for nuclear shielding of the present application has better shielding performance. To shield 0.1MeV neutrons, the thickness of the shielding material required for boron steel, B₄C/Al and the alloy material of the present application to reduce the neutron fluence rate (radiation intensity) to one tenth of the original value is 12 cm, 13.7 cm, and 9.54 cm respectively. In addition, the W element has excellent photon shielding effect. Therefore, under the same shielding effect, the dysprosium-rich nickel-tungsten alloy material for nuclear shielding of the present application may be thin and light, which is conducive to “weight/volume reduction” and optimization of space layout during use. The alloy material is the best candidate material for future replacement of traditional boron steel or B₄C/Al-based composite materials and other series, and is a high-efficiency neutron and photon collaborative shielding structure/function integrated material.

### BRIEF DESCRIPTION OF THE DRAWINGS

In order to illustrate the technical solutions of the embodiments of the present application more clearly, the accompanying drawing that needs to be used in the embodiments of the present application will be briefly introduced below. Apparently, the accompanying drawings described below are only the specific embodiments of the present application, and those skilled in the art can obtain other embodiments according to the following figures without making creative efforts.

FIG. 1 is a metallographic structure diagram of the dysprosium-rich nickel-tungsten alloy material for nuclear shielding in Embodiment 1 of the present application.

The accompanying drawings, which are incorporated in and constitute a part of the specification of the present application, illustrate embodiments consistent with the present application and together with the description serve to explain the principles of the present application.

### DETAILED DESCRIPTION

In order to better understand the technical solutions of the present application, the embodiments of the present application will be described in detail below in conjunction with the accompanying drawings.

### EMBODIMENT 1

A dysprosium-rich nickel-tungsten alloy material for nuclear shielding is provided, and its composition includes the following components in percentage (%) by mass: C: 0.02%, W: 20.0%, Cr: 15.0%, Dy: 3.0%, and a balance of nickel and unavoidable impurities.

A method for preparing the dysprosium-rich nickel-tungsten alloy material for nuclear shielding is adopted, which includes the following steps:
a. A vacuum induction melting process is adopted; and during raw material batching, the composition of the raw materials is batched according to the following composition in percentage (%) by mass:
Cr 15.0%;
Dy 3.0%;
W 20.0%;
C 0.02%;
Ni balance;

All the raw materials weighed after the batching are mixed; the vacuum induction melting process is adopted, and the prepared raw materials are put into a vacuum induction heating furnace, which is evacuated to 3×10⁻⁴ Pa; then high-purity argon is introduced as the protective gas; and the furnace is heated up to 1700° C. at a heating rate of 100°C/min and this temperature is maintained for 10 minutes to obtain an alloy melt;
b. the alloy melt prepared in step a is cast into shape, and the alloy ingot obtained by casting is sequentially subjected to hot forging, hot rolling and annealing heat treatment processes to finally obtain a neutron and photon collaborative shielding structure/function integrated nickel-based alloy rod.

### Experimental Test Analysis

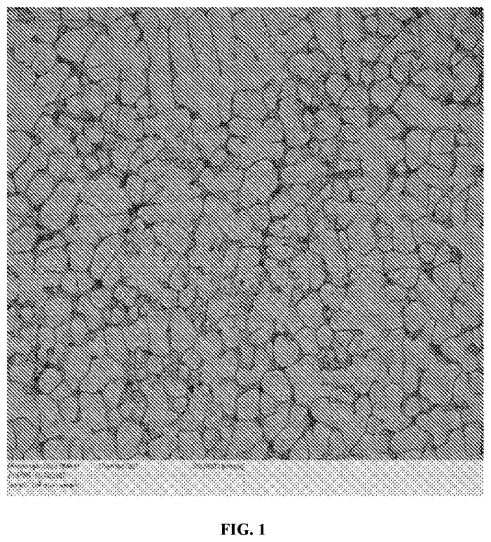

The metallographic structure of the dysprosium-rich nickel-tungsten alloy material for nuclear shielding in this embodiment is shown in FIG. 1. The structure is mainly composed of austenite and the second phase (Ni, Cr, W)₅Dy intermetallic compound. The second phase (Ni, Cr, W)₅Dy in the nickel-based alloy is distributed along the grain boundary of the austenite in the matrix. In this embodiment, the vacuum induction melting process is adopted. (Ni, Cr, W)₅Dy is formed by comprehensive batching and melting, and then cast into shape, followed by hot forging, hot rolling, annealing treatment and other processes to finally produce the neutron and photon collaborative shielding structure/function integrated nickel-based alloy rod.

After mechanical property testing, the test results show that the neutron and photon collaborative shielding structure/function integrated nickel-based alloy rod prepared in this embodiment has a tensile strength at break at room temperature of greater than 750 MPa, and an elongation at break of greater than 30.0%.

### EMBODIMENT 2

Embodiment 2 is basically the same as Embodiment 1, and the special features of Embodiment 2 are as follows.

In this embodiment, a dysprosium-rich nickel-tungsten alloy material for nuclear shielding is provided, and its composition includes the following components in percentage (%) by mass: C: 0.002%, W: 5.0%, Cr: 20.0%, Dy: 1.0%, and a balance of nickel and unavoidable impurities.

In this embodiment, a preparation method of the dysprosium-rich nickel-tungsten alloy material for nuclear shielding is adopted, which includes the following steps.
a. A vacuum induction melting process is adopted; and during raw material batching, the composition of the raw materials is batched according to the following composition in percentage (%) by mass:
Cr 20.0%;
Dy 1.0%;
W 5.0%;
C 0.002%;
Ni balance;

All the raw materials weighed after the batching are mixed, and the vacuum induction melting process is performed to obtain an alloy melt.
b. This step is the same as that in Embodiment 1.

### Experimental Test Analysis

The structure of the dysprosium-rich nickel-tungsten alloy material for nuclear shielding in this embodiment is mainly composed of austenite and the second phase (Ni, Cr, W)₅Dy intermetallic compound. The second phase (Ni, Cr, W)₅Dy in the nickel-based alloy is distributed along the grain boundary of the austenite in the matrix. In this embodiment, the vacuum induction melting process is adopted. (Ni, Cr, W)₅Dy is formed by comprehensive batching and melting, and then cast into shape, followed by hot forging, hot rolling, annealing treatment and other processes to finally produce the neutron and photon collaborative shielding structure/function integrated nickel-based alloy rod.

After mechanical property testing, the test results show that the neutron and photon collaborative shielding structure/function integrated nickel-based alloy rod prepared in this embodiment has a tensile strength at break at room temperature of greater than 650 MPa, and an elongation at break of greater than 40.0%.

### EMBODIMENT 3

Embodiment 3 is basically the same as Embodiment 1, and the special features of Embodiment 3 are as follows.

In this embodiment, a dysprosium-rich nickel-tungsten alloy material for nuclear shielding is provided, and its composition includes the following components in percentage (%) by mass: C: 0.002%, W: 15.0%, Cr: 30.0%, Dy: 2.0%, and a balance of nickel and unavoidable impurities.

In this embodiment, a method for preparing the dysprosium-rich nickel-tungsten alloy material for nuclear shielding is adopted, which includes the following steps.
a. A vacuum induction melting process is adopted; and during raw material batching, the composition of the raw materials is batched according to the following composition in percentage (%) by mass:
Cr 30.0%;
Dy 2.0%;
W 15.0%;
C 0.002%;
Ni balance;

All the raw materials weighed after the batching are mixed, and the vacuum induction melting process is performed to obtain an alloy melt;
b. This step is the same as that in Embodiment 1.

### Experimental Test Analysis

The structure of the dysprosium-rich nickel-tungsten alloy material for nuclear shielding in this embodiment is mainly composed of austenite and the second phase (Ni, Cr, W)₅Dy intermetallic compound. The second phase (Ni, Cr, W)₅Dy in the nickel-based alloy is distributed along the grain boundary of the austenite in the matrix. In this embodiment, the vacuum induction melting process is adopted. (Ni, Cr, W)₅Dy is formed by comprehensive batching and melting, and then cast into shape, followed by hot forging, hot rolling, annealing treatment and other processes to finally produce the neutron and photon collaborative shielding structure/function integrated nickel-based alloy rod.

After mechanical property testing, the test results show that the neutron and photon collaborative shielding structure/function integrated nickel-based alloy rod prepared in this embodiment has a tensile strength at break at room temperature of greater than 700 MPa, and an elongation at break of greater than 35.0%.

### EMBODIMENT 4

Embodiment 4 is basically the same as Embodiment 1, and the special features of Embodiment 4 are as follows.

In this embodiment, a dysprosium-rich nickel-tungsten alloy material for nuclear shielding is provided, and its composition includes the following components in percentage (%) by mass: C: 0.002%, W: 25.0%, Cr: 25.0%, Dy: 2.5%, and a balance of nickel and unavoidable impurities.

In this embodiment, a method for preparing the dysprosium-rich nickel-tungsten alloy material for nuclear shielding is adopted, which includes the following steps.
a. A vacuum induction melting process is adopted; and during raw material batching, the composition of the raw materials is batched according to the following composition in percentage (%) by mass:
Cr 25.0%;
Dy 2.5%;
W 25.0%;
C 0.002%;
Ni balance;

All the raw materials weighed after the batching are mixed, and the vacuum induction melting process is performed to obtain an alloy melt.
b. This step is the same as that in Embodiment 1.

### Experimental Test Analysis

The structure of the dysprosium-rich nickel-tungsten alloy material for nuclear shielding in this embodiment is mainly composed of austenite and the second phase (Ni, Cr, W)₅Dy intermetallic compound. The second phase (Ni, Cr, W)₅Dy in the nickel-based alloy is distributed along the grain boundary of the austenite in the matrix. In this embodiment, the vacuum induction melting process is adopted. (Ni, Cr, W)₅Dy is formed by comprehensive batching and melting, and then cast into shape, followed by hot forging, hot rolling, annealing treatment and other processes to finally produce the neutron and photon collaborative shielding structure/function integrated nickel-based alloy rod.

After mechanical property testing, the test results show that the neutron and photon collaborative shielding structure/function integrated nickel-based alloy rod prepared in this embodiment has a tensile strength at break at room temperature of greater than 780 MPa, and an elongation at break of greater than 25.0%.

### EMBODIMENT 5:

Embodiment 5 is basically the same as Embodiment 1, and the special features of Embodiment 5 are as follows.

In this embodiment, a dysprosium-rich nickel-tungsten alloy material for nuclear shielding is provided, and its composition includes the following components in percentage (%) by mass: C: 0.002%, W: 35.0%, Cr: 20.0%, Dy: 3.0%, and a balance of nickel and unavoidable impurities.

In this embodiment, a method for preparing the dysprosium-rich nickel-tungsten alloy material for nuclear shielding is adopted, which includes the following steps.
a. A vacuum induction melting process is adopted; and during raw material batching, the composition of the raw materials is batched according to the following composition in percentage (%) by mass:
Cr 20.0%;
Dy 3.0%;
W 35.0%;
C 0.002%;
Ni balance;

All the raw materials weighed after the batching are mixed, and the vacuum induction melting process is performed to obtain an alloy melt.
b. This step is the same as that in Embodiment 1.

### Experimental Test Analysis

The structure of the dysprosium-rich nickel-tungsten alloy material for nuclear shielding in this embodiment is mainly composed of austenite and the second phase (Ni, Cr, W)₅Dy intermetallic compound. The second phase (Ni, Cr, W)₅Dy in the nickel-based alloy is distributed along the grain boundary of the austenite in the matrix. In this embodiment, the vacuum induction melting process is adopted. (Ni, Cr, W)₅Dy is formed by comprehensive batching and melting, and then cast into shape, followed by hot forging, hot rolling, annealing treatment and other processes to finally produce the neutron and photon collaborative shielding structure/function integrated nickel-based alloy rod.

After mechanical property testing, the test results show that the neutron and photon collaborative shielding structure/function integrated nickel-based alloy rod prepared in this embodiment has a tensile strength at break at room temperature of greater than 850 MPa, and an elongation at break of greater than 20.0%.

### EMBODIMENT 6

Embodiment 6 is basically the same as Embodiment 1, and the special features of Embodiment 6 are as follows.

In this embodiment, a dysprosium-rich nickel-tungsten alloy material for nuclear shielding is provided, and its composition includes the following components in percentage (%) by mass: C: 0.002%, W: 23.0%, Cr: 18.0%, Dy: 4.0%, and a balance of nickel and unavoidable impurities.

In this embodiment, a method for preparing the dysprosium-rich nickel-tungsten alloy material for nuclear shielding is adopted, which includes the following steps.
a. A vacuum induction melting process is adopted; and during raw material batching, the composition of the raw materials is batched according to the following composition in percentage (%) by mass:
Cr 18.0%;
Dy 4.0%;
W 23.0%;
C 0.002%;
Ni balance;

All the raw materials weighed after the batching are mixed, and the vacuum induction melting process is performed to obtain an alloy melt.
b. This step is the same as that in Embodiment 1.

### Experimental Test Analysis

The structure of the dysprosium-rich nickel-tungsten alloy material for nuclear shielding in this embodiment is mainly composed of austenite and the second phase (Ni, Cr, W)₅Dy intermetallic compound. The second phase (Ni, Cr, W)₅Dy in the nickel-based alloy is distributed along the grain boundary of the austenite in the matrix. In this embodiment, the vacuum induction melting process is adopted. (Ni, Cr, W)₅Dy is formed by comprehensive batching and melting, and then cast into shape, followed by hot forging, hot rolling, annealing treatment and other processes to finally produce the neutron and photon collaborative shielding structure/function integrated nickel-based alloy rod.

After mechanical property testing, the test results show that the neutron and photon collaborative shielding structure/function integrated nickel-based alloy rod prepared in this embodiment has a tensile strength at break at room temperature of greater than 750 MPa, and an elongation at break of greater than 25.0%.

### EMBODIMENT 7

Embodiment 7 is basically the same as Embodiment 1, and the special features of Embodiment 7 are as follows.

In this embodiment, a dysprosium-rich nickel-tungsten alloy material for nuclear shielding is provided, and its composition includes the following components in percentage (%) by mass: C: 0.002%, W: 18.0%, Cr: 18.0%, Dy: 3.5%, and a balance of nickel and unavoidable impurities.

In this embodiment, a method for preparing the dysprosium-rich nickel-tungsten alloy material for nuclear shielding is adopted, which includes the following steps.
a. A vacuum induction melting process is adopted; and during raw material batching, the composition of the raw materials is batched according to the following composition in percentage (%) by mass:
Cr 18.0%;
Dy 3.5%;
W 18.0%;
C 0.002%;
Ni balance;

All the raw materials weighed after the batching are mixed, and the vacuum induction melting process is performed to obtain an alloy melt.
b. This step is the same as that in Embodiment 1.

### Experimental Test Analysis

The structure of the dysprosium-rich nickel-tungsten alloy material for nuclear shielding in this embodiment is mainly composed of austenite and the second phase (Ni, Cr, W)₅Dy intermetallic compound. The second phase (Ni, Cr, W)₅Dy in the nickel-based alloy is distributed along the grain boundary of the austenite in the matrix. In this embodiment, the vacuum induction melting process is adopted. (Ni, Cr, W)₅Dy is formed by comprehensive batching and melting, and then cast into shape, followed by hot forging, hot rolling, annealing treatment and other processes to finally produce the neutron and photon collaborative shielding structure/function integrated nickel-based alloy rod.

After mechanical property testing, the test results show that the neutron and photon collaborative shielding structure/function integrated nickel-based alloy rod prepared in this embodiment has a tensile strength at break at room temperature of greater than 750 MPa, and an elongation at break of greater than 25.0%.

In the dysprosium-rich nickel-tungsten alloy material for nuclear shielding of the present application, Dy has a large neutron absorption cross-section and is mainly used to improve the neutron shielding performance of the material; W has a large atomic number and good photon shielding effect, and is mainly used to improve the photon shielding performance; the addition of Cr improves the corrosion resistance of the material; and C can refine the grains and increase the strength of the material.

Comparing the material components of the above different embodiments, the content of C is relatively low, which has little effect on the strength and elongation of the material. The components with larger changes in these embodiments are W and Dy, and as the content of these two components increases, the material strength increases and the elongation decreases.

In the present application, by adjusting the content of each component and combining the vacuum induction melting process, the obtained dysprosium-rich nickel-tungsten alloy material for nuclear shielding has excellent mechanical properties and corrosion resistance, and plays a collaborative shielding effect on neutrons and photons. The use of the alloy material for parts such as pipes and plates for the storage and transportation of reactor spent fuel can significantly reduce material thickness and weight, optimize space layout and reduce raw material costs.

The above are only preferred embodiments of the present application, and are not intended to limit the present application. For those skilled in the art, the present application may have various modifications and changes. Any modifications, equivalent replacements, improvements, etc. made within the ideas and principles of the present application shall be included within the protection scope of the present application.

1. A dysprosium-rich nickel-tungsten alloy material for nuclear shielding, wherein a composition of the material comprises the following components in percentage by mass: C: 0.002-0.02%, W: 5.0-35.0%, Cr: 15.0-30.0%, Dy: 1.0-4.0%, and a balance of nickel and unavoidable impurities.

2. The dysprosium-rich nickel-tungsten alloy material for nuclear shielding according to claim 1, wherein the composition of the material comprises the following components in percentage by mass: C: 0.002-0.02%, W: 5.0-25.0%, Cr: 15.0-30.0%, Dy: 1.0-4.0%, and the balance of nickel and unavoidable impurities.

3. The dysprosium-rich nickel-tungsten alloy material for nuclear shielding according to claim 1, wherein the composition of the material comprises the following components in percentage by mass: C: 0.002-0.02%, W: 5.0-25.0%, Cr: 15.0-25.0%, Dy: 1.0-3.0%, and the balance of nickel and unavoidable impurities.

4. The dysprosium-rich nickel-tungsten alloy material for nuclear shielding according to claim 1, wherein the composition of the material comprises the following components in percentage by mass: C: 0.002-0.02%, W: 15.0-25.0%, Cr: 15.0-20.0%, Dy: 1.0-3.5%, and the balance of nickel and unavoidable impurities.

5. The dysprosium-rich nickel-tungsten alloy material for nuclear shielding according to claim 1, wherein a structure of the dysprosium-rich nickel-tungsten alloy material for nuclear shielding consists essentially of austenite and a second phase (Ni, Cr, W)₅Dy intermetallic compound.

6. The dysprosium-rich nickel-tungsten alloy material for nuclear shielding according to claim 5, wherein the second phase (Ni, Cr, W)₅Dy intermetallic compound in the dysprosium-rich nickel-tungsten alloy material for nuclear shielding is distributed along a grain boundary of the austenite in a matrix.

7. The dysprosium-rich nickel-tungsten alloy material for nuclear shielding according to claim 1, wherein after being subjected to hot forging, hot rolling and annealing heat treatment processes, the dysprosium-rich nickel-tungsten alloy material for nuclear shielding has a tensile strength at break at room temperature in a range of 650-850 MPa, and an elongation at break in a range of 20.0-40.0%.

8. A method for preparing the dysprosium-rich nickel-tungsten alloy material for nuclear shielding according to claim 1, comprising the following steps:
(1) mixing all raw materials weighed after batching the raw materials according to the composition in percentage by mass, and performing vacuum induction melting by adopting a vacuum induction melting process to obtain an alloy melt; and
(2) casting the alloy melt prepared in step (1) into shape to obtain an alloy ingot, and performing hot forging, hot rolling and annealing heat treatment processes on the alloy ingot sequentially to finally obtain the dysprosium-rich nickel-tungsten alloy material for nuclear shielding.

9. The method for preparing the dysprosium-rich nickel-tungsten alloy material for nuclear shielding according to claim 8, wherein the vacuum induction melting process comprises the following steps:
a. putting the raw materials weighed after batching into a vacuum induction heating furnace, evacuating the furnace to 3×10⁻⁴ Pa, and then introducing argon gas therein as a protective gas; and
b. heating the vacuum induction heating furnace up to 1700° C. at a heating rate of 100°C/min, and maintaining the temperature for 10 minutes to obtain the alloy melt.
